(19) United States
(12) Patent Application Publication
(10) Pub. No.: US 2014/0239019 A1
(43) Pub. Date: Aug. 28, 2014

(54) Device and a Method for Distributing Flowable or Pourable Substances, in Particular Air Chocolate

(71) Applicant: BÜHLER GmbH, Bergneustadt (DE)

(72) Inventor: Frank Altjohann, Bergneustadt (DE)

(21) Appl. No.: 14/347,415

(22) PCT Filed: Sep. 26, 2012
(86) PCT No.: PCT/EP2012/068982

§ 371 Date: Mar. 26, 2014

(30) Foreign Application Priority Data
Sep. 26, 2011 (EP) 11182783.8

(51) Int. Cl. B65D 83/00

(52) U.S. Cl. CPC A23G 7/00; A23G 7/005
USPC 222/394; 29/401.1; 222/450

(57) ABSTRACT

A device for distributing flowable or pourable substances, for example chocolate, has at least one metering element with at least one metering channel that can be brought into fluidic connection with a substance container and a substance destination. The device also has at least one closure element that can be moved between a first position in which the substance cannot exit the metering channel in the direction of the substance destination and a second position in which the substance can exit the metering channel in the direction of the substance destination.

The invention relates to a device and a method for distributing flowable or pourable substances, for example aerated chocolate, as well as to an attachment part for converting a casting machine, a method for converting a casting machine, and the use of a device for distributing flowable or pourable substances.

The substance is typically filled into openings of molding plates, which are moved forward, for example, by a conveyor belt beneath a substance container. The openings into which the pourable substance flows can be provided in one or more mutually adjacent rows on the molding plate.

The distribution of the substances flowing out of the substance container is realized through metering channels in metering elements, for example rotary slide valves, which are disposed in a main body beneath the storage container in the transverse direction to the motional axis of the conveyor belt.

The substance flows out of the substance container, for example through an inlet opening of the main body, into the metering channels, and from there, for example through a discharge opening of the main body, to a substance destination, where the substance, if this is chocolate substance, for example, can generally solidify.

The substance is generally propelled through the metering channels by means of pumps.

Beneath the main body in the direction of flow is generally found a casting plate having casting channels, which latter correspond with the openings of the molding plate and transport the substance from the metering channels to the openings.

A device of this type is known, for example, from DE 1782745, which device is in the form of a casting machine for chocolate and similar flowable or pasty substances, for distributing such substances into molding troughs which move around beneath the storage container.

Casting machines of this type are not suitable for casting aerated or pressurized substances, since the substance would expand uncontrollably in the metering channels and/or casting channels. Aerated substances, that is to say substances to which a blowing agent has been added, are generally cast with purpose-built machines, in which the substance is frothed up with a gas immediately before being filled into the molding plate. These devices are not normally suitable for the casting of smooth substances.

By a smooth substance is below understood a substance which has a density between 1 kg/l and 1.5 kg/l, whereas a pressurized substance has a density from about 0.4 kg/l to 0.7 kg/l. Aerated, pressurized flowable substance is kept in a substance container at a pressure of about 6-10 bar, whereas smooth substances experience in the substance container only atmospheric pressure, or their own weight pressure.

The defined object is therefore to avoid the drawbacks of that which is known and to present a device and a method with which both smooth and pressurized substances can be precisely cast.

The object is achieved by a device for distributing a flowable substance, in particular a consumable product, according to the features of claim 1. The device has at least one metering element, having at least one metering channel, which latter can be brought into fluidic connection, on the one hand, with a substance container and, on the other hand, with a substance destination. The device further has a closure element, which is settable between a first position, in which substantially no substance can exit the metering channel in the direction of the substance destination, and a second position, in which substance can exit the metering channel in the direction of the substance destination.

The metering channel can thus be purposefully closed by the closure element. This ensures that the substance to be cast can expand during the metering only in the metering channel and does not already start to exit the metering channel before casting is due to be commenced at the substance destination.

The casting is initiated once the molding plate is suitably positioned and all metering channels are filled and ready for casting. For smooth substances, the time of the casting is generally defined with a pumping motion in the direction of the substance destination. Pressurized substance expands even without pumping motion, however, and can already leave the metering channel before the optimal time for the casting is reached, for example when not yet all metering channels are filled or the molding plate is not yet ready for the casting. The possibility of premature substance discharge could lead to imprecise metering, and thus to inaccuracies in the weight of the cast substance.

The closure element enables the outflow time for the flowing of the substance out of the metering channels to be accurately defined and to be coordinated for all metering channels. The metering channels can be opened and emptied successively or simultaneously.

As the closure element, a slide valve, for example, is provided, by means of which all metering channels can be closed and opened simultaneously.

In an advantageous embodiment of the invention, the device has at least one main body, having a cavity which can be brought into fluidic connection with the substance container via at least one intake opening and with the substance destination, in the environment of the main body, via at least one discharge opening. The intake opening and the discharge opening are arranged on the main body at a distance apart in a casting direction (L). The metering element, in particular a rotary slide valve, is movable between a first position, in which the metering channel is fluidically connected to the intake opening, and a second position, in which the metering channel is fluidically connected to the discharge opening. The at least one discharge opening is closable with the closure element.

The metering elements generally have a plurality of metering channels, intake and discharge openings. Upon the movement of the metering element from the first into the second position, a metering channel can enter into fluidic connection with a discharge opening, which, after the second position is reached, is fluidically connected to another metering channel The closure element prevents substance from exiting the metering channel in this intermediate position. The closure element is only opened once all metering channels are fluidically connected to the associated discharge opening.

Advantageously, the device possesses at least one pumping element, for drawing substance out of the substance container into the metering channel and for ejecting substance from the metering channel

The pumping element can act directly on the substance container or it can cooperate with the metering element. Preferably, the pumping element, in a first phase, draws substance out of the substance container into the metering channel and, in a second phase, forces the substance out of the metering channel to the substance destination. Particularly preferably, the pumping element consists of a piston arrangement, which can be brought into fluidic connection with metering channels of a metering element in the form of a rotary slide valve.

Advantageously, the device has a casting plate having at least one casting channel, wherein the casting channel creates a fluidic connection between the metering channel and the substance destination. In particular, the casting channel is fluidically connected to the discharge opening.

The casting channels connect the outlets of the metering channels to the respective substance destinations, and the casting plate thus determines the casting pattern. Casting plates can be exchangeably mounted, so that the casting pattern can be altered.

In the casting of smooth substances, the casting channels also prevent dripping, since excess substance is drawn back up into the casting channel by the capillary effect.

The dripping, in particular of aerated substances, can further be prevented if the device has a second closure element, with which the casting channel is separately closable.

Preferably, the device has a substance container which can be pressurized, in particular for the reception of a substance to be kept under pressure, such as air-containing chocolate.

The object is further achieved by a method as claimed in claim 7 for distributing a flowable substance, in particular a consumable product, more particularly aerated chocolate, with a device as described above, wherein a substance, in particular a pressurized substance, is first provided in a substance container. The closure element is brought into a first position, so that the metering channel, at least in the direction of the substance destination, is closed. The metering element is now brought into fluidic connection with the substance container and substance can flow into the metering channel Preferably, a pumping element ensures that the substance flows in. After the substance has flowed into the metering channel, the metering element is moved into the second position, in which the metering channel is fluidically connected to the discharge opening. After this, the discharge opening is opened with the closure element, so that the substance can flow out of the metering channel to the substance destination. Preferably, the pumping element ensures that the substance flows out. Preferably, the substance flows out of the discharge opening to the substance destination through a casting channel of a casting plate. The closure element prevents the premature flowing of substance into the casting channel, whereby the casting is realized with greater precision, and thus greater accuracy in terms of weight.

The object is further achieved by an attachment part as claimed in claim 8 for converting casting machines having at least one metering element.

The attachment part according to the invention has at least one closure element and can be mounted onto the casting machine such that the closure element is settable between a first position, in which no substance can exit the metering element in the direction of a substance destination, and a second position, in which substance can exit the metering element in the direction of the substance destination.

With the attachment part, traditional casting machines for the casting of smooth substances can be converted, so that they are also suitable for casting pressurized substances.

The object is also achieved by a method for converting casting machines having at least one metering element with an attachment part as is described above.

In particular, the attachment part is fitted to a casting machine, which has a main body having a cavity which can be brought into fluidic connection with the substance container via at least one intake opening, and with the substance destination, in the environment of the main body, via at least one discharge opening wherein the intake opening and the discharge opening are arranged on the main body at a distance apart in a casting direction (L), wherein the metering element, in particular a rotary slide valve, is movable between a first position, in which the metering channel is fluidically connected to the intake opening, and a second position, in which the metering channel is fluidically connected to the discharge opening.

The attachment part is fitted in such a way that the at least one discharge opening is closable with the closure element.

The object is further achieved by the use of a device, as described above, for casting pressurized, flowable substance, in particular a consumable product, more particularly aerated chocolate.

The invention is explained in greater detail below in illustrative embodiments with reference to drawings, wherein:

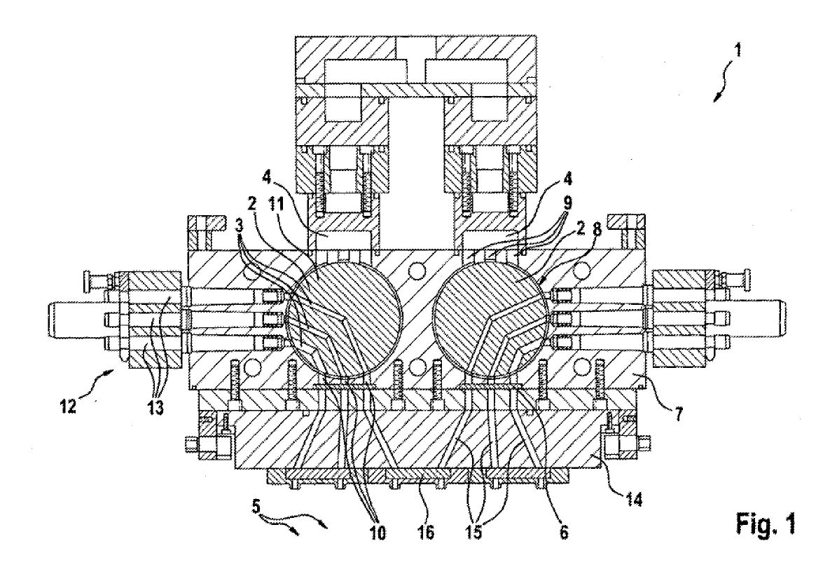

FIG. 1 shows a sectional representation of a device according to the invention;

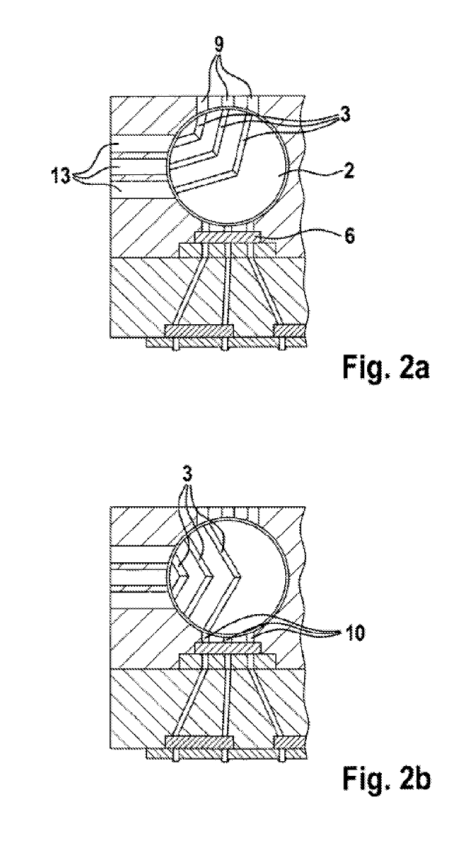

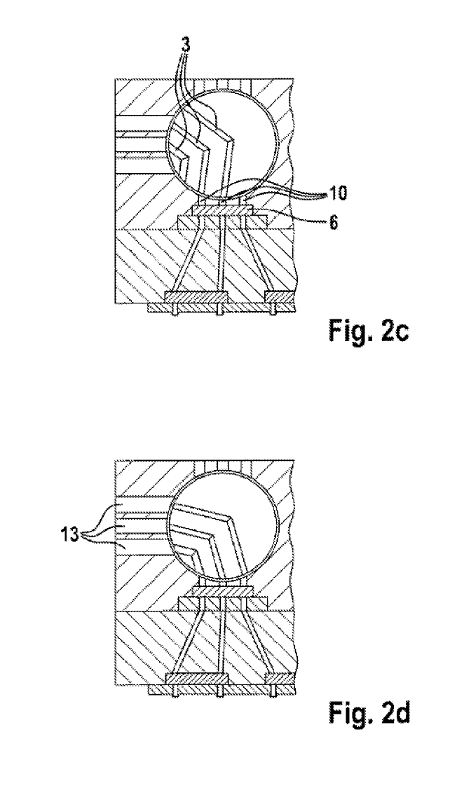

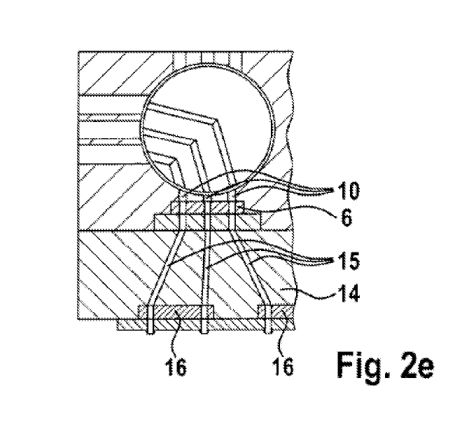

FIGS. 2a-2e show schematically the sequence of a metering cycle with the aid of sectional representations of a device according to the invention.

FIG. 1 shows a sectional representation of a device 1 according to the invention.

The device 1 has two metering elements 2, each having three metering channels 3 which can be brought into fluidic connection, on the one hand, with substance feed channels 4 fluidically connected to a substance container (not shown explicitly) and, on the other hand, with substance destinations 5.

The device has for each metering element 2 a closure element 6.

The metering elements 2 are disposed in a main body 7. This possesses for each metering element a cavity 8, which can be brought into fluidic connection with the substance container 4 via intake openings 9 and with the substance destination 5 via discharge openings 10.

In the shown illustrative embodiment, the metering elements 2 are rotary slide valves 11, having a rotational axis lying perpendicular to the plane of the sectional representation.

The rotary slide valves 11 are movable between a first position, in which the metering channels 3 are respectively fluidically connected to corresponding intake openings 9, and a second position, in which, as shown in the figure, the metering channels 3 are respectively fluidically connected to corresponding discharge openings.

The discharge openings 10 are closable with the closure element 6.

The device 1 further has for each metering element pumping elements 12 for drawing substance out of the substance container into the metering channel and for ejecting substance from the metering channel

The pumping elements 12 comprise piston arrangements 13, which can be brought into fluidic connection with the metering channels 3.

The device 1 is equipped with a casting plate 14, which for each discharge opening 10 has a casting channel 15. The casting channels are closable with a further closure element 16.

The sequence of a casting cycle is illustrated schematically with the aid of the sectional representations in FIGS. 2a-2e.

In FIG. 2a, the metering channels 3 of the metering element 2 are fluidically connected to the intake openings 9. The piston arrangements 13 of the pumping element draw substance into the metering channels 3. The closure element 6 is closed.

Once the metering channels 3 are filled, the metering element 2 is rotated, as is shown in FIGS. 2b and 2c. The metering channels can here enter into fluidic connection with non-corresponding discharge openings 10.

The closed closure element 6 prevents, however, a discharge of substance from the metering channels 3.

The casting operation may only commence once each metering channel 3 is fluidically connected to the corresponding discharge opening 10, as is shown in FIG. 2d.

Only then is each metering channel once again connected to a corresponding piston arrangement 13.

The closure element 6 is now opened, as shown in FIG. 2e, and the substance is forced by the pumping element out of the metering channels, through the discharge openings and the casting channels 15 of the casting plate 14, in the direction of the substance destination.

The closure elements 16 for closing the casting channels 15 are now also open. After a suitable outflow time they are closed, and any substance which may be left behind cannot drip.

By the one selection of closure elements 16 to be opened, the casting pattern can be set. Depending on the molding plate to be filled, only a part of the second closure elements 16 is opened.

1-10. (canceled)

11. A device for distributing a flowable substance, wherein the device has:
at least one metering element, having at least one metering channel, which latter can be brought into fluidic connection, on the one hand, with a substance container and, on the other hand, with a substance destination,
wherein the device has at least one closure element, which is settable between a first position, in which substantially no substance can exit the metering channel in the direction of the substance destination, and a second position, in which substance can exit the metering channel in the direction of the substance destination.

12. The device as claimed in claim 11, wherein the flowable substance a consumable product.

13. The device as claimed in claim 11, wherein the device has at least one main body, having a cavity which can be brought into fluidic connection with the substance container via at least one intake opening and with the substance destination, in the environment of the main body, via at least one discharge opening, wherein the intake opening and the discharge opening are arranged on the main body at a distance apart in a casting direction, wherein the metering element is movable between a first position, in which the metering channel is fluidically connected to the intake opening, and a second position, in which the metering channel opening is fluidically connected to the discharge opening, and the at least one discharge opening is closable with the closure element.

14. The device as claimed in claim 13, wherein the metering element is a rotary slide valve.

15. The device as claimed in claim 11, wherein the device has at least one pumping element, for drawing substance out of the substance container into the metering channel and for ejecting substance from the metering channel.

16. The device as claimed in claim 11, wherein the device has a casting plate having at least one casting channel, wherein the casting channel creates a fluidic connection between the metering channel and the substance destination.

17. The device as claimed in claim 16, wherein the casting channel is fluidically connected to the discharge opening.

18. The device as claimed in claim 16, wherein the device has a second closure element, with which the casting channel is closable.

19. The device as claimed in claim 11, wherein the device has a substance container which can be pressurized, in particular for the reception of a substance to be kept under pressure, such as air-containing chocolate.

20. The device as claimed in claim 19, wherein the device has a substance container for the reception of a substance to be kept under pressure.

21. The device as claimed in claim 20, wherein the substance to be kept under pressure is an air-containing chocolate.

22. A method for distributing a flowable substance with a device as claimed in claim 11, comprising the following steps:
provision of a substance in a substance container;
bringing of the closure element into a first position, so that the metering channel, at least in the direction of the substance destination, is closed;
bringing of the metering channel into fluidic connection with the substance container;
movement of the metering element into a second position, in which the metering channel is fluidically connected to the discharge opening, after substance has flowed into the metering channel;
opening of the discharge opening with the closure element.

23. The method as claimed in claim 22 wherein the flowable substance is a consumable product.

24. The method as claimed in claim 23 wherein the consumable product is an aerated chocolate.

25. The method as claimed in claim 22 wherein the flowable substance is a pressurized substance.

26. An attachment part for converting casting machines having at least one metering element, wherein the attachment part has at least one closure element and can be mounted onto the casting machine such that the closure element is settable between a first position, in which no substance can exit the metering element in the direction of a substance destination, and a second position, in which substance can exit the metering element in the direction of the substance destination.

27. A method for converting casting machines having at least one metering element, wherein an attachment part as claimed in claim 26 is fitted to the casting machine, wherein the attachment part is fitted in such a way that the at least one discharge opening is closable with the closure element.

28. The method as claimed in claim 27, wherein the attachment part is fitted to a main body having a cavity which can be brought into fluidic connection with the substance container via at least one intake opening, and with the substance destination, in the environment of the main body, via at least one discharge opening, wherein the intake opening and the discharge opening are arranged on the main body at a distance apart in a casting direction, wherein the metering element is movable between a first position, in which the metering channel is fluidically connected to the intake opening, and a second position, in which the metering channel is fluidically connected to the discharge opening.

29. The method as claimed in claim 28, wherein the metering element is a rotary slide valve.
